(19) United States
(12) Patent Application Publication
(10) Pub. No.: US 2007/0025554 A1
(43) Pub. Date: Feb. 1, 2007

(54) Remote control association methodology

(76) Inventor: Ping-Wen Ong, Laguna Niguel, CA (US)

Correspondence Address: CHRISTIE, PARKER & HALE, LLP, PO BOX 7068, PASADENA, CA, 91109-7068, US

(21) Appl. No.: 11/194,245

(22) Filed: Aug. 1, 2005

(51) Int. Cl. H04K 1/00; H04L 9/00

(52) U.S. Cl. 380/278; 380/270; 380/273

(57) ABSTRACT

An infrared remote device, such as a remote control, provides an encryption key to wireless radio frequency (RF) capable devices for use in wireless RF communications. The encryption key is provided using infrared transmissions. The infrared remote device may generate the encryption key and transmit the encryption key to other devices. The infrared device may also request an encryption key from one device, and provide the encryption to another device.

### BACKGROUND OF THE INVENTION

The present invention relates generally to wireless communication, and more particularly to methods and systems for using infrared communication to provide encryption keys for use in wireless RF data communication.

Consumer electronic devices often provide information to other consumer electronic devices. For example, receivers, set-top boxes, and other devices often provide audio and/or video information to televisions, monitors, speakers, home theater systems, etc. The use of wireless communication by consumer devices is becoming increasingly more prevalent. The benefits of wireless communication are manifold. Wireless devices may be positioned in a variety of locations without the encumbrance of wires or cables interconnecting devices. This affords the opportunity to easily move and position devices as well as increase visual aesthetics relating to a device.

With increasing data rates available for wireless communication, particularly wireless radio frequency (RF) communication, the number of devices able to communicate wirelessly increases. For example, increased data rates, provided by for example UWB (Ultra Wide Band) devices, provides sufficient bandwidth for communication of audiovisual information or other types of information that make use of high data transfer rates.

A disadvantage of wireless communication, particularly wireless RF communication, is decreased security or privacy in the transmitted data. For example, control information passed from one device to another may be instead be sent from an undesired third party or device. As another example, data, such as audiovisual information, transmitted from a set-top box to a television monitor may allow others to view, intercept, or otherwise have access to the data. While this may not be particularly troublesome in many instances, for example when the data is for a television show such as “Sesame Street”, in some instances security or privacy concerns may be significant. For example, the data may be a confidential audiovisual conference or a consumer may simply not wish others to know what audiovisual material is viewed by the consumer.

One option is to provide security features, such as encryption, between the devices passing data. A potential flaw in encryption of RF data is that the passing of encryption keys by RF means from one device to another may also be intercepted, rendering the encryption scheme superfluous.

### SUMMARY OF THE INVENTION

The invention provides remote control security association methods and associated devices and systems. An aspect of the invention provides a method of providing devices an encryption key for use in wireless radio frequency (RF) communication, comprising transmitting an encryption key to a first device using infrared (IR) communication; and transmitting the encryption key to a second device using IR communication. Another aspect of the invention provides a remote control for use in providing encryption information using infrared communication, the encryption information for use in wireless radio frequency communication between two other devices, comprising: an infrared transmitter; a controller, configured to command transmission of an encryption by the infrared transmitter and memory associated with the controller; and memory associated with the controller.

These and other aspects of the invention are more fully understood on review of the drawings and description herein.

### BRIEF DESCRIPTION OF THE DRAWINGS

FIG. 1 illustrates a block diagram of a system in accordance with aspects of the invention;

FIG. 2 is a flow diagram of a process in accordance with aspects of the invention;

FIG. 3 is a block diagram of a remote control in accordance with aspects of the invention.

FIG. 4 illustrates a further block diagram of a system in accordance with aspects of the invention;

FIG. 5 is a further flow diagram of a process in accordance with aspects of the invention; and

FIG. 6 is a further block diagram of a remote control in accordance with aspects of the invention.

### DETAILED DESCRIPTION

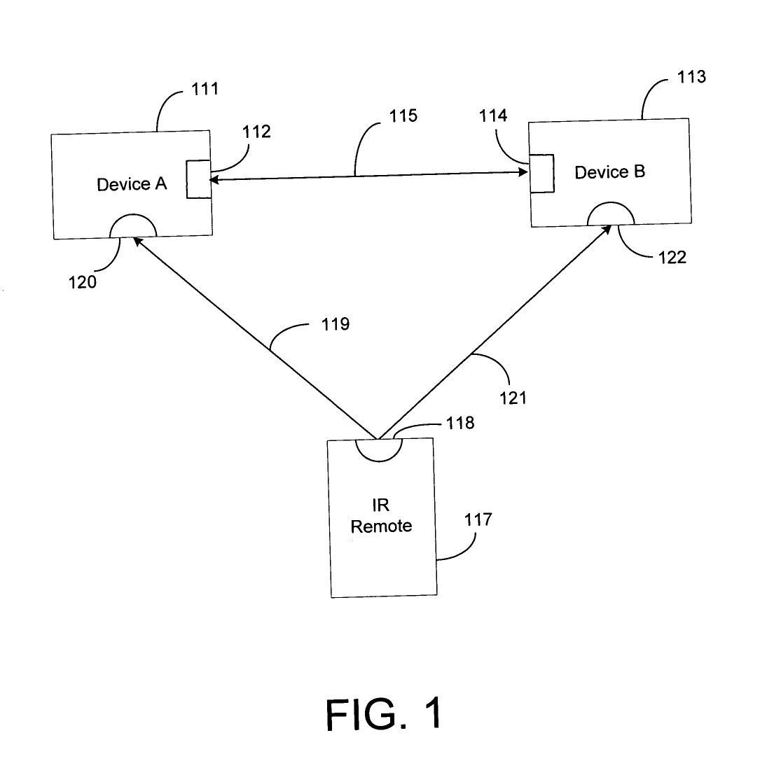

In FIG. 1 a Device A 111 and a Device B 113 communicate over a wireless radio frequency (RF) communication link 115. Accordingly, Device A includes an RF transceiver 112 and Device B includes an RF transceiver 114, along with associated circuitry. In some embodiments the RF transceivers are implemented as separate RF transmitters and separate RF receivers. Depending on device capabilities, in some embodiments, Device A or Device B may not both include both an RF transmitter and an RF receiver. For example, in some embodiments Device A may only transit RF data and Device B may only receive RF data, or vice versa. In addition, as is expected in wireless RF communication, although illustrated as a defined direct pathway, the wireless RF communication link should generally be considered as not being constrained over a particular pathway by, e.g., wires.

In some embodiments Device A is a source of audiovisual material, such as a cable set top box, satellite set-top box, DVD player, or other source of audiovisual information and Device B is a television or monitor. In such an embodiment Device A is a data source and Device B is a data sink. In various embodiments, however, both Device A and Device B may be data sources and data sinks, and in some embodiments control information may also be passed over the wireless RF link. In some embodiments Device A and Device B may be any number of consumer electronic devices in data communication and/or control communication with one another. In some embodiments further devices, such as home audio systems for use in a home theatre system, form additional devices which also communicate with Device A and/or Device B over wireless RF communication links.

A remote device 117 is also in data communication with Device A and Device B. The remote device is an infrared remote device. The remote device is therefore an infrared remote device. The infrared remote device may be, for example, of the type similar to remote controls commonly used to operate television devices, stereo devices, and other consumer electronic devices.

The infrared remote device communicates using infrared transmissions. Accordingly, infrared remote device includes an infrared transmitter 118, Device A includes an infrared receiver 120 and Device B includes an infrared receiver 122. In various embodiments, however, some or all of the devices include both IR receivers and IR transmitters, which may be combined as transceivers.

As illustrated in FIG. 1, the infrared remote device communicates with Device A over infrared transmission link 119 and with Device B over infrared transmission link 121. Although generally restricted to line of sight communication, the infrared transmission link should not generally be considered constrained to a particular predefined pathway.

The infrared remote device generates an encryption key and provides the encryption key to Device A and Device B using infrared communication techniques. The infrared communication techniques may be, for example, in accordance with the Infrared Data Association (IrDA) standards, proprietary standards, or in other formats. An advantage of passing encryption keys using infrared transmissions is that infrared transmissions generally have a shorter range than RF transmissions, and are also less likely to escape the confines of a home, office or other dwelling or enclosure. This allows the encryption key to be passed in the more secure fashion than through the use of wireless RF communication, thereby reducing the possibility that untoward parties may receive or interpret the encryption key.

Device A and Device B perform a security association function using wireless RF communication. In performing the security association, Device A and Device B each check that the other device has the correct encryption key and that each device is using appropriate communication techniques.

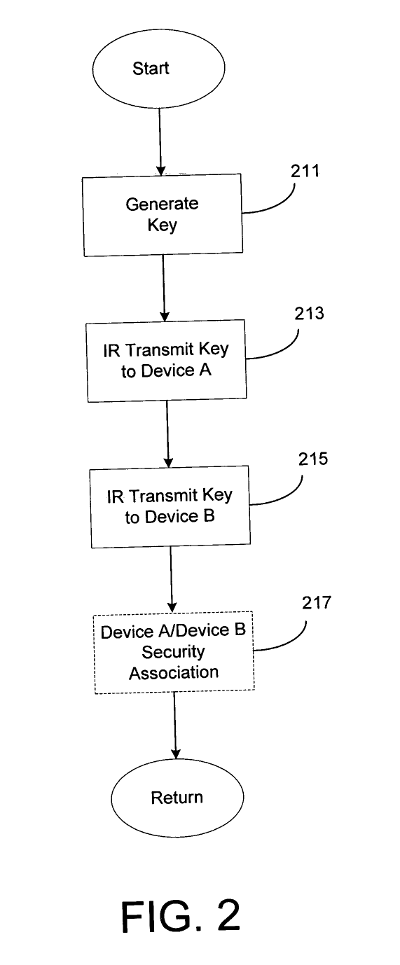

In one embodiment the infrared remote device performs a method in accordance with the process of the flow diagram of FIG. 2. In block 211, of the process of FIG. 2, a key is generated. The key is an encryption key. The encryption key is a multi-bit value which may be used to encrypt uncoded data and decrypt coded data. The encryption key may be generated by a variety of techniques, such as through multiplication of very large prime numbers or other methods. The key may also be stored in memory of the remote device or selected from a plurality of stored keys.

In block 213 the key is transmitted using infrared transmissions to Device A. The key may be transmitted to Device A using IrDA communication standards, proprietary standards, or other methods. Similarly, in block 215 the key is transmitted to Device B using infrared transmissions. In some embodiments Device A is turned on prior to transmission of the key in block 213, and in some embodiments Device B is turned on prior to transmission of the key in block 215.

In optional block 217 Device A and Device B perform a security association using the encryption key. The security association is performed using wireless RF communication. In some embodiments the security association includes, in addition to authentication by each device that the other device has the encryption key, application of an encryption algorithm and/or an integrity algorithm. For example, data communication between Device A and Device B is encrypted or decrypted using the encryption key, and the devices may communicate information sufficient for the devices to perform a security association for example using a four-way handshake methodology, in which these two devices use the encryption key to generate session keys to be used in the session without sending the encryption key using RF communications.

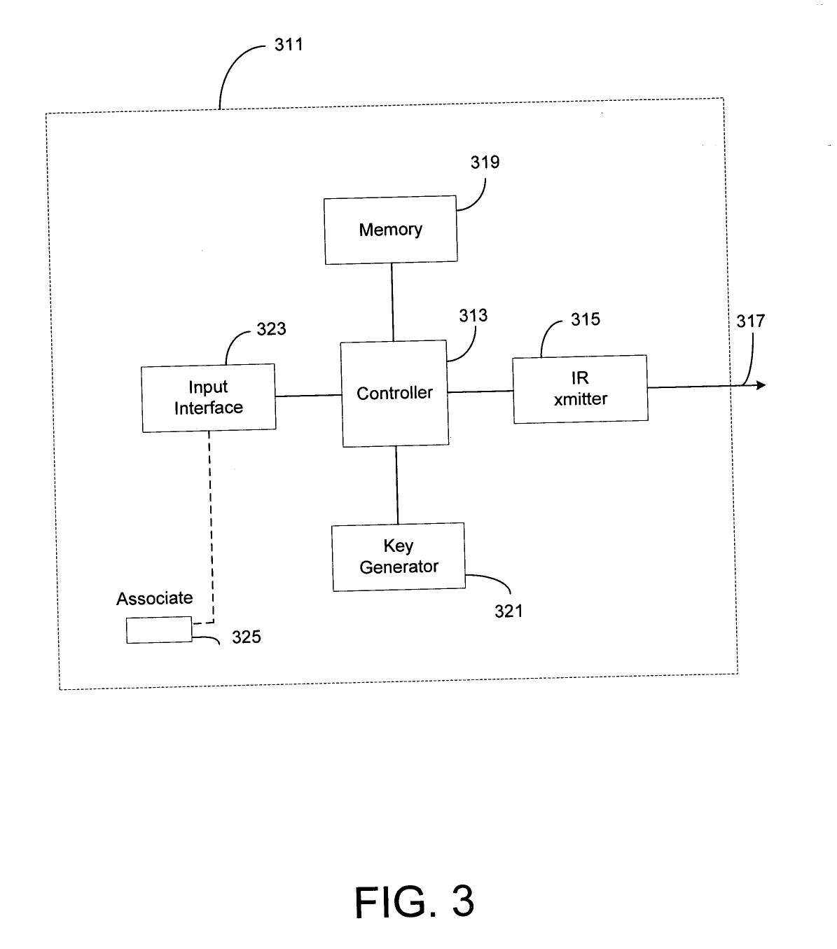

FIG. 3 is a block diagram of an infrared transmitter device in accordance with aspects of the invention. The infrared transmitter device has an IR transmitter 315. The IR transmitter provides an IR signal 317 for reception by external devices, such as Device A and Device B of FIG. 1. The IR transmitter, as illustrated in FIG. 3, receives commands and data from a controller 313. The controller, in various embodiments, is a processor, a microprocessor, a programmed integrated circuit, or dedicated circuitry. Associated with the controller is a memory 319. In some embodiments the memory may be registers within the controller, or may be separate from the controller.

As illustrated, the device includes a key generator 321. The key generator generates encryption keys which, as illustrated, are passed to the controller, which in turn passes the keys to the IR transmitter. In some embodiments communication between the controller, the IR transmitter, and the key generator are accomplished by way of a common bus, with data passed directly to or read by a specific component. In some embodiments the controller includes key generation functions, and the use of a separate key generator component is not required.

The controller also has an interface 323 which receives inputs from, for example, a keypad, whether push button, membrane or otherwise associated with or part of the controller. As illustrated in FIG. 3, the keypad includes an associate button. In some embodiments the associate button is a separate button, in other embodiments a multifunction button or other input method is provided. The associate button is read by an input interface 323, which processes keypad inputs. The input interface provides appropriate information to the controller, which arranges for or performs generation of an encryption key and for transmission by the IR transmitter of the encryption key.

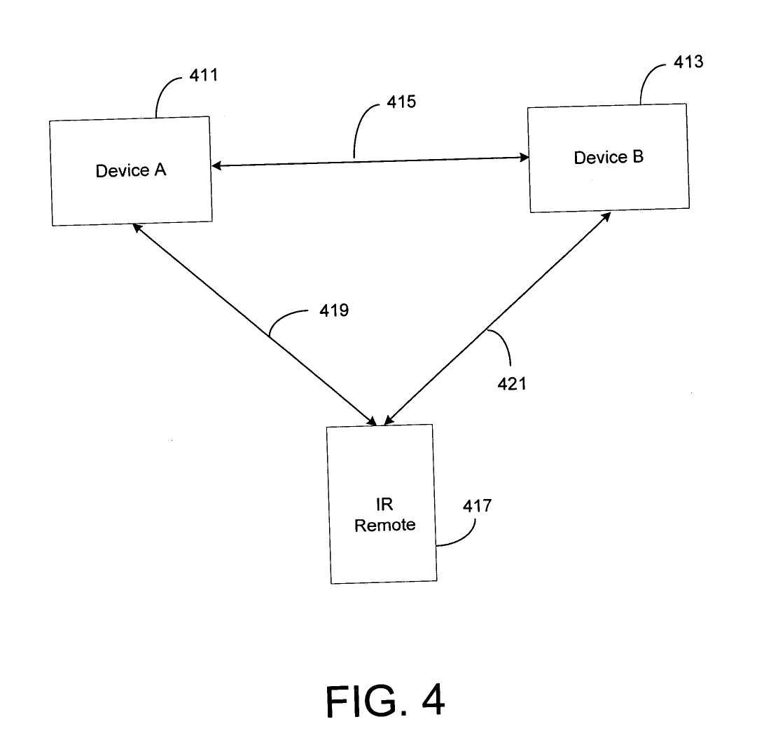

FIG. 4 is a block diagram of a further system in accordance with aspects of the invention. In the system of FIG. 4 Device A and Device B both have two-way communication with an infrared remote control, although in some embodiments only Device A or Device B is capable of two-way communication with the IR remote control. Broadly, in the system of FIG. 4, a first device, for example Device A, generates an encryption key and provides the IR remote control the encryption key using infrared communications. The IR remote control provides the encryption key to Device B, again using infrared communications. Device A and Device B perform a security association using the encryption key and communicate using RF methods.

In more detail, in FIG. 4 a Device A 411 and a Device B 413 communicate over a wireless RF communication link 415. Although not explicitly shown in FIG. 4, Device A and Device B each include RF transmission and/or reception components for transmitting and/or receiving RF information. In one embodiment Device A is a source of audiovisual material, such as a cable set-top box, satellite set-top box, DVD player, or other source of audiovisual information and Device B is a television or monitor. In such an embodiment Device A is a data source and Device B is a data sink. In various embodiments, however, both Device A and Device B may be data sources and data sinks, and in some embodiments control information may also be passed over the wireless RF link. In some embodiments Device A and Device B may be any number of consumer electronic devices in data and/or control communication with one another. In some embodiments further devices, such as home audio systems for use in a home theatre system, form additional devices which also communicate with Device A and/or Device B over wireless RF communication links.

A remote device 417 is also in data communication with Device A and Device B. The remote device is an infrared remote device. The infrared remote device may be, for example, of the type similar to remote controls commonly used to operate television devices, stereo devices, and other consumer electronic devices, with the infrared remote device communicating using infrared transmissions.

As illustrated in FIG. 4, the infrared remote device communicates with Device A over infrared transmission link 419 and with Device B over infrared transmission link 421. Accordingly, although not explicitly shown in FIG. 4, the infrared remote device, Device A and Device B each have infrared transmission components and/or infrared receiver components. As shall be clear from the discussion the infrared remote device includes both infrared transmission components and infrared receiver components, although at least some of the components may be combined.

Device A generates an encryption key and provides the encryption key to the infrared remote device using infrared communication techniques. The infrared communication techniques may be, for example, in accordance with IrDA standards, proprietary standards, or other formats. The infrared remote device passes the encryption key to Device B, also using infrared communication techniques.

An advantage of passing encryption keys using infrared transmissions is that infrared transmissions generally have a shorter range than RF transmissions, and are also less likely to escape the confines of a home, office or other dwelling or enclosure. This allows the encryption key to be passed in the more secure fashion than through the use of wireless RF communication, thereby reducing the possibility that untoward parties may receive the encryption key.

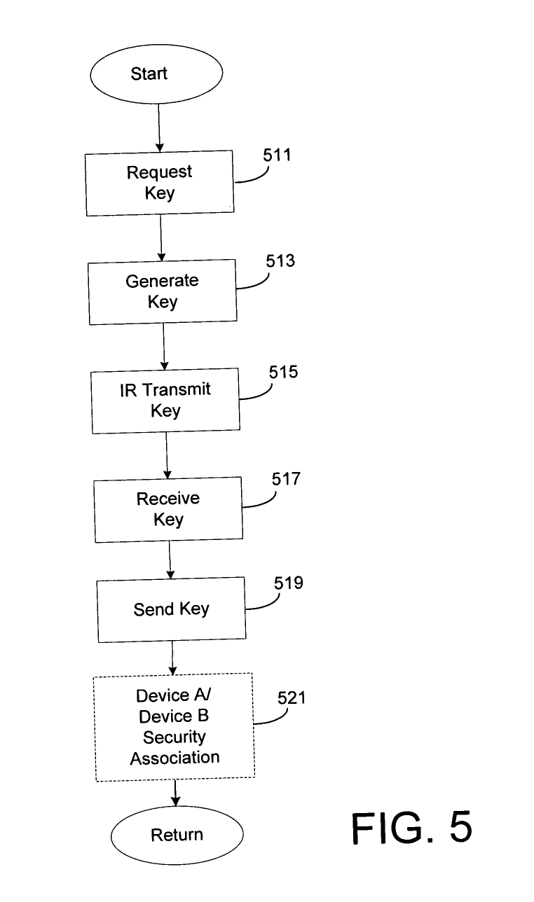

In one embodiment the system performs a method in accordance with the process of the flow diagram of FIG. 5. In block 511 the infrared remote device transmits a request for an encryption key to Device A. In block 513 Device A generates a key. The key is an encryption key. The encryption key is a multi-bit value which may be used to encrypt and decrypt coded data. The encryption key may be generated by a variety of techniques, such as through multiplication of very large prime numbers or other methods. The key may also be stored in memory of the remote device or selected from a plurality of stored keys. In some embodiments Device A includes a key generator. The key generator generates the encryption key, and the key generator may be circuitry configured to generate an encryption key or a processor programmed to generate an encryption key.

In block 515 the key is transmitted by Device A using infrared transmission to the infrared remote control. The key may be transmitted to the infrared remote control using IrDA communication standards, proprietary standards, or other methods. In block 517 the infrared remote control receives the key. In block 519 the infrared remote control transmits the key to Device B using infrared transmissions.

In optional block 521 Device A and Device B perform a security association using the encryption key. The security association is performed using wireless RF communication. In some embodiments the security association includes, in addition to authentication that each device has the encryption key, application of an encryption algorithm and/or an integrity algorithm. For example, data communication between Device A and Device B is encrypted or decrypted using the encryption key, and the devices may communicate information sufficient for the devices to perform a security association for example using a four-way handshake methodology, in which these two devices use the encryption key to generate session keys to be used in the session without sending the encryption key using RF communications.

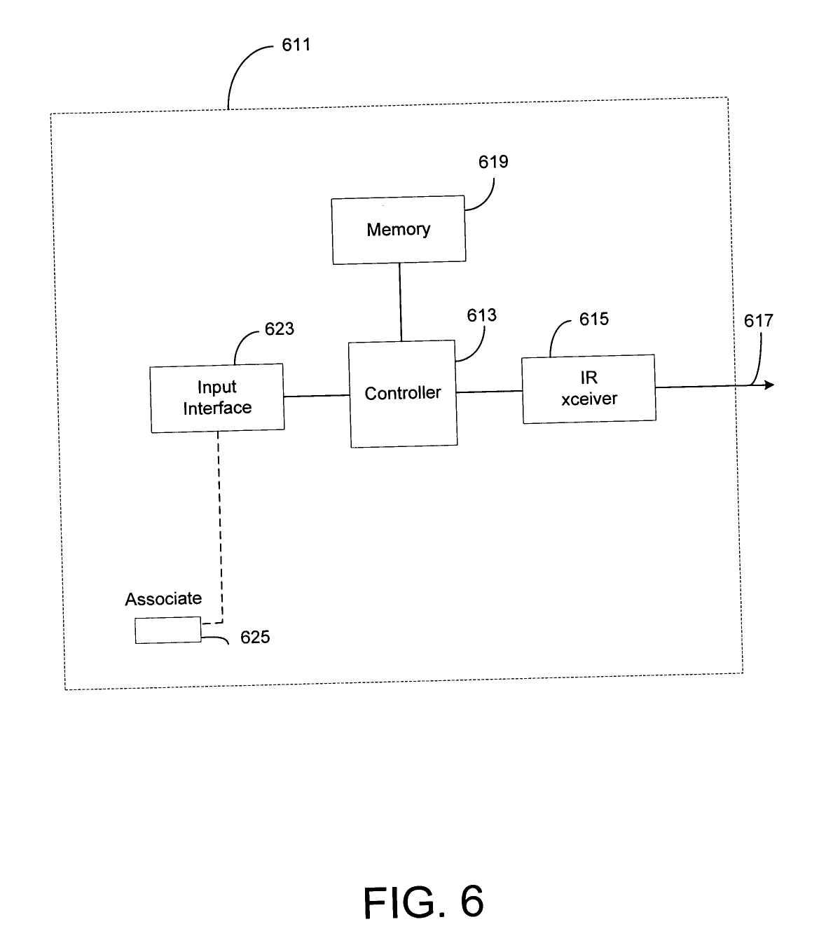

FIG. 6 is a block diagram of an infrared transmitter device in accordance with aspects of the invention. The infrared transmitter device has an IR transceiver 615. The IR transceiver provides an IR signal 617 for reception by external devices, such as Device A and Device B of FIG. 4. The IR transceiver also receives IR signals from Device A and/or Device B. The IR transceiver, as illustrated in FIG. 6, receives commands and data from a controller 613. Associated with a controller is a memory 619. In some embodiments the memory may be registers within the controller, or may be separate from the controller.

The controller also has an interface 623 which receives inputs from, for example, a keypad, whether push button, membrane or otherwise associated with or part of the controller. As illustrated in FIG. 6, the keypad includes an associate button. In some embodiments the associate button is a separate button, in other embodiments a multifunction button or other input method is provided. The associate button is read by an input interface 623, which processes keypad inputs. The input interface provides appropriate information to the controller, which arranges for or requests an encryption key and for transmission by the IR transmitter of the encryption key. In some embodiments the controller determines if memory of the remote device stores a previously received encryption key and the IR transmitter should therefore transmit the encryption key. In some embodiments the controller determines if the remote device has received an encryption key within a predefined time period and the IR transmitter should therefore transmit the encryption key. In other embodiments the controller uses various techniques to determine if a request for an encryption key should be made or if an encryption key should be transmitted.

Accordingly, remote control related security association methods, devices and systems are disclosed. Although the invention has been described with respect to certain embodiments, it should be recognized that the invention includes the claims and their equivalents supported by this disclosure.

What is claimed is:

1. A method of providing devices an encryption key for use in wireless radio frequency (RF) communication, comprising:
transmitting an encryption key to a first device using infrared (IR) communication; and
transmitting the encryption key to a second device using IR communication.

2. The method of claim 1 further comprising generating the encryption key.

3. The method of claim 2 wherein:
generating the encryption key is performed by a remote control device;
transmitting the encryption key to the first device using IR communication is performed by the remote control device; and
transmitting the encryption key to the second device using IR communication performed by the remote control device.

4. The method of claim 2 wherein:
generating the encryption key is performed by a third device;
transmitting the encryption key to the first device using IR communication is performed by the third device; and
transmitting the encryption key to the second device using IR communication is performed by the first device.

5. The method of claim 4 wherein the first device is a remote control device.

6. The method of claim 1 further comprising performing a security association between the first device and the second device.

7. The method of claim 6 wherein performing the security association between the first device and the second device is performed using wireless RF communication between the first device and the second device.

8. The method of claim 1 wherein a third device transmits the encryption key to the first device.

9. The method of claim 8 wherein the first device transmits the encryption key to the second device.

10. The method of claim 5 further comprising performing a security association between the third device and the second device.

11. The method of claim 10 wherein performing the security association between the third device and the second device is performed using wireless RF communication between the third device and the second device.

12. A remote control for use in providing encryption information using infrared communication, the encryption information for use in wireless radio frequency communication between two other devices, comprising:
an infrared transmitter;
a controller, configured to command transmission of an encryption by the infrared transmitter; and
memory associated with the controller.

13. The remote control of claim 12, further comprising key generator circuitry for generating the encryption key.

14. The remote control of claim 12 wherein the controller is further configured to generate an encryption key.

15. The remote control of claim 12, further comprising an infrared receiver.

16. The remote control of claim 15 wherein the controller is further configured to command transmission by the infrared transmitter of a request for transmission of the encryption key.
